(19) United States
(12) Patent Application Publication
(10) Pub. No.: US 2026/0269509 A1
(43) Pub. Date: Sep. 10, 2026

(54) HYBRID CONNECTOR AND CONNECTOR ASSEMBLY

(71) Applicant: Xuancheng Luxshare Precision Industry Co., Ltd., Xuancheng City (CN)

(72) Inventors: Ankang SHENG, Xuancheng City (CN); Weihe HONG, Xuancheng City (CN); Haomai YIN, Xuancheng City (CN)

(73) Assignee: Xuancheng Luxshare Precision Industry Co., Ltd., Xuancheng City (CN)

(21) Appl. No.: 19/362,625

(22) Filed: Oct. 20, 2025

(30) Foreign Application Priority Data
Mar. 10, 2025 (CN) 202510275852.X

(51) Int. Cl. H01R 13/436; H01R 13/426; H01R 13/514; H01R 13/516; H01R 13/52

(52) U.S. Cl. CPC H01R 13/4365; H01R 13/426; H01R 13/514; H01R 13/516; H01R 13/5219

(57) ABSTRACT

A hybrid connector includes an insulating body, a first locking member and a second locking member, where a first mounting hole inserted with a first terminal and a second mounting hole inserted with a second terminal are disposed on the insulating body, a first fastener that is snap-fit with the first terminal is disposed in the first mounting hole, and a second fastener that is snap-fit with the second terminal is disposed in the second mounting hole; the first locking member is detachably inserted into the insulating body and is capable of limiting the first fastener to enable the first fastener to keep locking the first terminal; the second locking member is detachably inserted into the insulating body and is capable of performing secondary locking on the second terminal.

### CROSS-REFERENCE TO RELATED APPLICATION(S)

This application claims priority to Chinese Patent Application No. 202510275852.X filed on Mar. 10, 2025, the disclosure of which is incorporated herein by reference in its entirety.

### TECHNICAL FIELD

The present application relates to the field of connectors and, for example, to a hybrid connector and a connector assembly.

### BACKGROUND

As a type of in-vehicle sensor, a lidar can transmit sensed information to in-vehicle processing devices. As the demands for intelligence increase, the amount of sensing information is increasing, and high-speed transmission requirements are generated between the lidar and the in-vehicle processing devices. In addition, there are also low-speed transmission requirements with a small volume of data such as control information between the in-vehicle processing devices and the lidar. To reduce the requirement for wiring space, the lidar is connected to the in-vehicle processing devices through a hybrid connector.

In the related art, the hybrid connector generally includes an insulating body and at least two terminals with different functions disposed in the insulating body. To enable each terminal to be locked in the insulating body, the terminal is formed with a snap portion suitable to be snapped on the insulating body. However, in complex transportation or application environments, the hybrid connector may encounter unexpected situations such as mechanical vibration, impacts, temperature changes, etc., and these situations may lead to the disengagement of the snap portion from the insulating body and thus cause the terminal to be disengaged from the insulating body, thereby affecting the assembly stability of the hybrid connector and the signal connection stability between the hybrid connector and a docking connector.

### SUMMARY

The present application provides a hybrid connector and a connector assembly to solve the problem of unstable performance of the hybrid connector and the connector assembly caused by unstable connections between the terminals and the insulating body.

A hybrid connector is provided. The hybrid connector includes an insulating body, a first terminal, a second terminal, a first locking member and a second locking member. A first mounting hole and a second mounting hole are disposed on the insulating body. A first fastener is disposed in the first mounting hole, and a second fastener is disposed in the second mounting hole. The first terminal is inserted into the first mounting hole and snap-fitted with the first fastener. The first locking member is detachably inserted into the insulating body and fitted with the first fastener in a position-limiting manner. The second terminal is inserted into the second mounting hole and snap-fitted with the second fastener. The second locking member is detachably inserted into the insulating body and is capable of locking the second terminal snap-fitted with the second fastener.

Optionally, the first locking member has a pre-assembled position and a final locking position with respect to the insulating body, the first locking member in the pre-assembled position is configured to allow the first terminal to be inserted into the first mounting hole, and the first locking member in the final locking position is configured to limit a position of the first terminal; and/or the second locking member has a pre-assembled position and a final locking position with respect to the insulating body, the second locking member in the pre-assembled position is configured to allow the second terminal to be inserted into or removed from the second mounting hole, and the second locking member in the final locking position is configured to lock the second terminal.

Optionally, the first mounting hole and the second mounting hole extend in a first direction. The first locking member is configured to move in the first direction to switch between the pre-assembled position and the final locking position. The second locking member is configured to move in a third direction to switch between the pre-assembled position and the final locking position, where the third direction is perpendicular to the first direction.

Optionally, the first locking member includes a sleeve portion and an insertion portion. The sleeve portion is connected to the insertion portion and located outside the insertion portion. The sleeve portion is sleeved outside the insulating body. When the first locking member is in the final locking position, the inner side of the insertion portion abuts against the side of the first fastener facing away from the first terminal.

Optionally, an avoidance groove is disposed on the second locking member. The avoidance groove on the second locking member in the pre-assembled position faces the second terminal, and the avoidance groove on the second locking member in the final locking position is staggered with respect to the second terminal.

Optionally, the hybrid connector further includes a housing. The housing is sleeved on the insulating body.

Optionally, an operation hole is opened on the side of the housing corresponding to the second locking member. The orthographic projection area of the second locking member in a direction towards the operation hole is larger than the area of the operation hole.

Optionally, the hybrid connector further includes a third locking member. The third locking member is configured to be inserted into the housing and is configured to be capable of locking a docking connector plug-fitted with the hybrid connector.

Optionally, the first terminal is a terminal for transmitting an Ethernet signal, and the second terminal is a low-voltage terminal.

A connector assembly is provided. The connector assembly includes the hybrid connector described above and a docking connector plug-fitted with the hybrid connector.

### BRIEF DESCRIPTION OF DRAWINGS

FIG. 1 is a structural view of a hybrid connector at an angle according to an embodiment of the present application;

FIG. 2 is a structural view of the hybrid connector at another angle according to an embodiment of the present application;

FIG. 3 is an exploded view of the hybrid connector according to an embodiment of the present application;

FIG. 4 is a side view of the hybrid connector according to an embodiment of the present application;

FIG. 5 is a sectional view taken in an A-A direction in FIG. 4;

FIG. 6 is a sectional view taken in a B-B direction in FIG. 4 when the first locking member is in the pre-assembled position;

FIG. 7 is a sectional view taken in the B-B direction in FIG. 4 when the first locking member is in the final locking position;

FIG. 8 is a sectional view taken along a C-C direction in FIG. 4;

FIG. 9 is a rear view of the hybrid connector with the housing hidden;

FIG. 10 is a sectional view taken in a D-D direction in FIG. 9 when the second locking member is in the pre-assembled position;

FIG. 11 is a sectional view taken in the D-D direction in FIG. 9 when the second locking member is in the final locking position;

FIG. 12 is a structural view of the insulating body at an angle according to an embodiment of the present application;

FIG. 13 is a structural view of the insulating body at another angle according to an embodiment of the present application;

FIG. 14 is a structural view of the first locking member according to an embodiment of the present application;

FIG. 15 is a structural view of the first terminal according to an embodiment of the present application;

FIG. 16 is a structural view of the second locking member according to an embodiment of the present application;

FIG. 17 is a structural view of the second terminal according to an embodiment of the present application;

FIG. 18 is a rear view of the hybrid connector with the housing on according to an embodiment of the present application;

FIG. 19 is a sectional view taken in an E-E direction in FIG. 18 when the third locking member is in the pre-assembled position;

FIG. 20 is a sectional view taken in the E-E direction in FIG. 18 when the third locking member is in the final locking position;

FIG. 21 is a structural view of the third locking member according to an embodiment of the present application;

FIG. 22 is a structural view of the housing at an angle according to an embodiment of the present application;

FIG. 23 is a structural view of the housing at another angle according to an embodiment of the present application;

FIG. 24 is a structural view of the first sealing ring according to an embodiment of the present application; and

FIG. 25 is a structural view of the second sealing ring according to an embodiment of the present application.

### In the drawings:

1. insulating body; 11. first mounting hole; 111. first hole opening; 112. second hole opening; 12. second mounting hole; 121. third hole opening; 122. fourth hole opening; 13. first fastener; 131. first elastic arm; 132. first snap block; 14. second fastener; 141. second elastic arm; 142. second snap block; 15. first limiting stop block; 151. first stop surface; 152. guide groove; 16. second limiting stop block; 161. third stop surface; 17. first positioning block; 18. fixing groove; 19. second groove hole; 110. mounting groove; 120. third positioning block;

2. first terminal; 21. front shielding case; 211. first abut surface; 212. guide block; 213. second abut surface; 22. rear shielding case; 221. first recess;

3. second terminal; 31. second recess; 32. avoidance groove; 33. third abut surface;

4. first locking member; 41. sleeve portion; 411. avoidance notch; 42. insertion portion; 421. step surface; 422. second stop surface; 43. first groove hole;

5. second locking member; 51. cantilever portion; 511. locking portion; 512. mounting portion; 513. avoidance groove; 514. second positioning block; 515. avoidance hole; 52. connection portion; 521. force application groove;

6. housing; 61. operation hole; 62. third groove hole; 63. outlet hole; 64. third fastener; 641. third elastic arm; 642. connecting rod; 643. third recess; 644. connecting block; 65. insertion hole; 66. fourth positioning block;

7. third locking member; 71. locking arm; 72. locking groove; 73. positioning arm; 731. fourth groove hole; 74. push-pull plate;

8. first sealing ring; 81. first annular protrusion; 82. second annular protrusion; 83. sealing body; 84. through hole;

9. second sealing ring; 91. third annular protrusion; 92. fourth annular protrusion;

10. first cable;

20. second cable;

30. end cover.

### DETAILED DESCRIPTION

The present application is described below in detail in conjunction with drawings and embodiments. It is to be understood that the embodiments described herein are intended to explain the present application and not to limit the present application. Additionally, it is to be noted that for ease of description, only part, not all, of the structures related to the present application are illustrated in the drawings.

In the description of the present application, the terms "joined", "connected", and "secured" are to be understood in a broad sense unless otherwise expressly specified and limited. For example, the term "connected" may refer to "securely connected", "detachably connected", or integrated, may refer to "mechanically connected" or "electrically connected", or may refer to "connected directly", "connected indirectly through an intermediary", "connected inside two elements", or an "interaction relation between two elements". For those of ordinary skill in the art, specific meanings of the preceding terms in the present application may be understood based on specific situations.

In the present application, unless otherwise expressly specified and limited, when a first feature is described as "above" or "below" a second feature, the first feature and the second feature may be in direct contact, or the first feature and the second feature may be in contact via another feature between the two features instead of being in direct contact. Moreover, when the first feature is described as "on", "above", or "over" the second feature, the first feature is right on, above, or over the second feature, the first feature is obliquely on, above, or over the second feature, or the first feature is simply at a higher level than the second feature. When the first feature is described as "under", "below", or "underneath" the second feature, the first feature is right under, below, or underneath the second feature, the first feature is obliquely under, below, or underneath the second feature, or the first feature is simply at a lower level than the second feature.

In the description of the present application, orientations or position relations indicated by terms such as "upper", "lower", "left", and "right" are based on the drawings. These orientations or position relations are intended only to facilitate and simplify the description of the present application and not to indicate or imply that a device or element referred to must have such particular orientations or must be configured or operated in such particular orientations. Thus, these orientations or position relations are not to be construed as limiting the present application. In addition, the terms "first" and "second" are merely used for distinguishing between descriptions and have no special meanings.

An embodiment of the present application provides a hybrid connector and a connector assembly. The connector assembly includes a hybrid connector and one docking connector (not shown) capable of being plug-fit with the hybrid connector. It is to be understood that one of the hybrid connector and the docking connector is disposed on the device body of one device which is, for example, an in-vehicle processing device such as a domain controller or an In-Vehicle Infotainment, IVI, and the other is connected through a cable to another device which is, for example, an in-vehicle device such as a lidar or a gateway. The specific structure of the hybrid connector is described in detail below by using the hybrid connector provided with cables as an example.

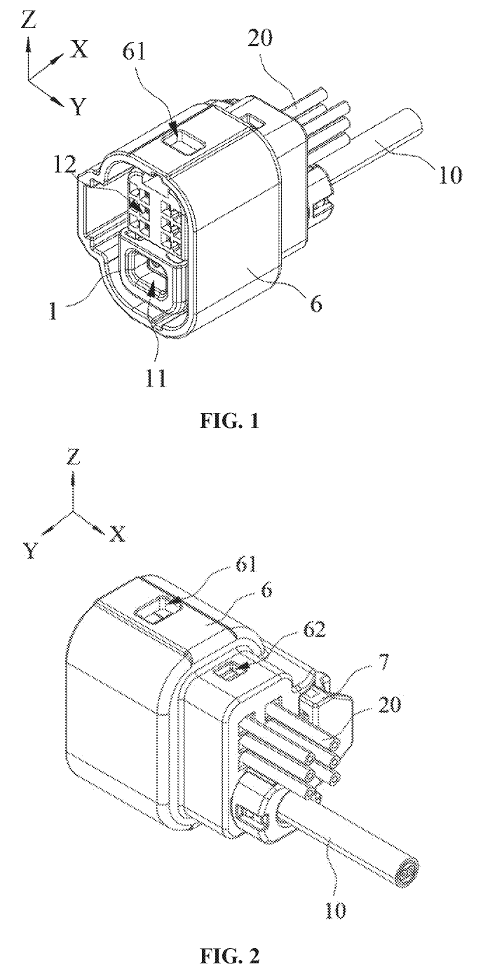

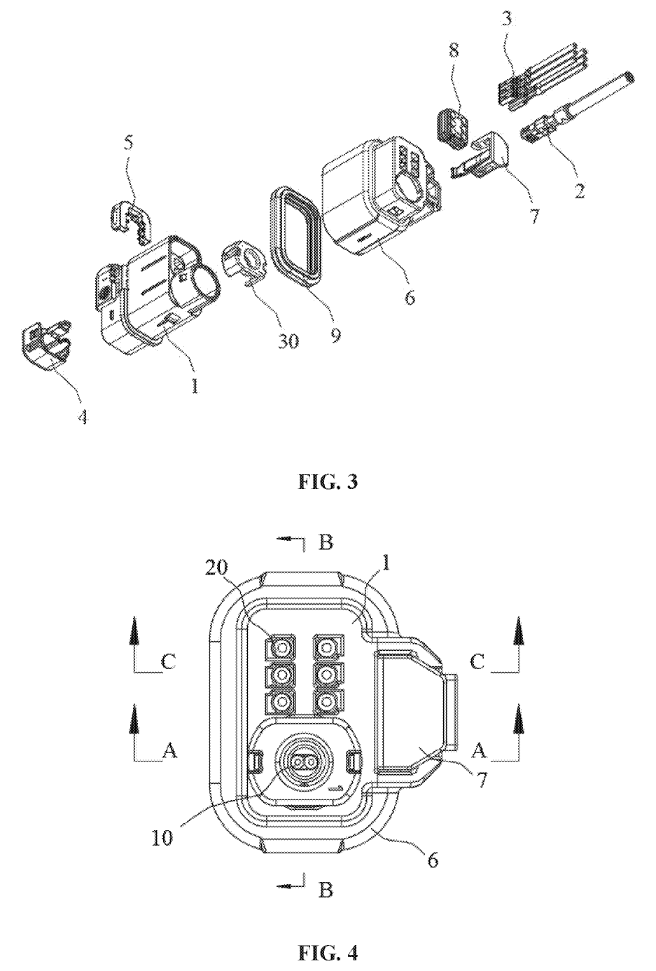

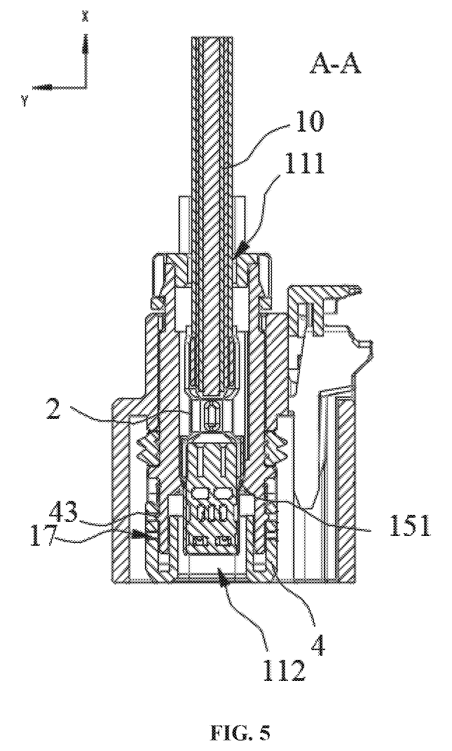

Referring to FIGS. 1-3, the hybrid connector includes an insulating body 1, a first terminal 2, a second terminal 3, a first locking member 4 and a second locking member 5. A first mounting hole 11 and a second mounting hole 12 are opened on the insulating body 1. The first terminal 2 and the second terminal 3 are inserted into the first mounting hole 11 and the second mounting hole 12, respectively. A first fastener 13 and a second fastener 14 are disposed in the first mounting hole 11 and the second mounting hole 12, respectively. The first fastener 13 is snap-fitted with the first terminal 2 to lock the first terminal 2 at a preset position in the first mounting hole 11. The second fastener 14 is snap-fitted with the second terminal 3 to lock the second terminal 3 at a preset position in the second mounting hole 12. The first locking member 4 and the second locking member 5 are detachably inserted into the insulating body 1. The first locking member 4 is capable of limiting a position of the first fastener 13 to enable the first fastener 13 to keep locking the first terminal 2. The second locking member 5 is capable of performing secondary locking on the second terminal 3 snap-fitted with the second fastener 14.

In the hybrid connector and the connector assembly, the first fastener 13 performs primary locking on the first terminal 2, and then the first locking member 4 limits the position of the first fastener 13 to enable the first fastener 13 to keep locking the first terminal 2, thereby improving the connection stability between the first terminal 2 and the insulating body 1. The second fastener 14 performs primary locking on the second terminal 3, and the second locking member 5 performs secondary locking on the second terminal 3, thereby improving the connection stability between the second terminal 3 and the insulating body 1 and improving the performance stability of the entire hybrid connector and the connector assembly.

In this embodiment, the first terminal 2 and the second terminal 3 are connected to a first cable 10 and a second cable 20, respectively, and the functions of the first terminal 2 and the second terminal 3 are different. For example, the first terminal 2 is a terminal for transmitting an Ethernet signal, and then the first cable 10 connected to the first terminal 2 is a high-speed signal cable; the second terminal 3 is a low-voltage terminal for transmitting a low-speed Controller Area Network, CAN, signal, and then the second cable 20 connected to the second terminal 3 is a low-voltage cable. To accommodate the first terminal 2 and the second terminal 3, the internal spaces of the first mounting hole 11 and the second mounting hole 12 are different, and the internal space of the first mounting hole 11 is larger than the internal space of the second mounting hole 12.

In this embodiment, the first locking member 4, the second locking member 5 and the insulating body 1 are all injection molded. The first locking member 4 and the second locking member 5 each have a pre-assembled position and a final locking position. The first locking member 4 in the pre-assembled position allows the first terminal 2 to be inserted into the first mounting hole 11, and the first locking member 4 in the final locking position limits the first fastener 13 to prevent the first fastener 13 from being disengaged from the first terminal 2. The second locking member 5 in the pre-assembled position allows the second terminal 3 to be inserted into or removed from the second mounting hole 12, and the second locking member 5 in the final locking position locks the second terminal 3. In the assembly process of the hybrid connector, the first locking member 4 and the second locking member 5 may be first assembled on the insulating body 1 and both are in the pre-assembled position, and then the first terminal 2 and the second terminal 3 may be assembled on the insulating body 1, thereby reducing the possibility of loss of the first locking member 4 and the second locking member 5.

Specifically, referring to FIGS. 1 and 2, both the first mounting hole 11 and the second mounting hole 12 extend in a first direction (the X direction and its reverse direction in FIG. 1, where the X direction is the forward direction of the first direction and the reverse direction of the X direction is the reverse direction of the first direction). To reduce the difficulty of assembling the first locking member 4 and the second locking member 5 on the insulating body 1 due to the limitation on the sizes of the internal spaces of the first mounting hole 11 and the second mounting hole 12, the first locking member 4 moves in the first direction to switch between the pre-assembled position and the final locking position, and the second locking member 5 then moves in a third direction (the Z direction and its reverse direction in FIG. 1, where the Z direction is the forward direction of the third direction and the reverse direction of the Z direction is the reverse direction of the third direction) to switch between the pre-assembled position and the final locking position, where the third direction is perpendicular to the first direction.

In this embodiment, the first mounting hole 11 and the second mounting hole 12 are disposed at intervals in the third direction, and the number of the first mounting holes 11 and the number of the second mounting holes 12 are not specifically limited in the embodiments of the present application. For example, the number of the first mounting holes 11 is 1, and the number of the second mounting holes 12 is 6. The six second mounting holes 12 are arranged in two rows symmetrically in a second direction (the Y direction and its reverse direction in FIG. 1, where the Y direction is the forward direction of the second direction and the reverse direction of the Y direction is the reverse direction of the second direction). Each row of the second mounting holes 12 includes three second mounting holes 12 disposed at intervals in the third direction. The number of second terminals 3 is the same as the number of second mounting holes 12 and is also 6. At this point, the second locking member 5 moving in the third direction is capable of simultaneously locking multiple second terminals 3, and the second direction is perpendicular to the first direction and the third direction.

Referring to FIGS. 5-7, the first mounting hole 11 has a first hole opening 111 and a second hole opening 112 disposed opposite each other in the first direction, and the first hole opening 111 is disposed on the side of the second hole opening 112 in the forward direction of the first direction. The first terminal 2 may be inserted into the first mounting hole 11 from the first hole opening 111 and move in the direction towards the second hole opening 112. A first docking terminal, adapted to the first terminal 2, on the docking connector may be electrically connected to the first terminal 2 through the second hole opening 112. A first stop surface 151 is disposed on the side of the inner wall of the first mounting hole 11 near the second hole opening 112. The first stop surface 151 may abut against a first abut surface 211 on the first terminal 2 to stop the first terminal 2 from continuing to move in the direction towards the second hole opening 112 so that the first terminal 2 is inserted into the preset position in the first mounting hole 11.

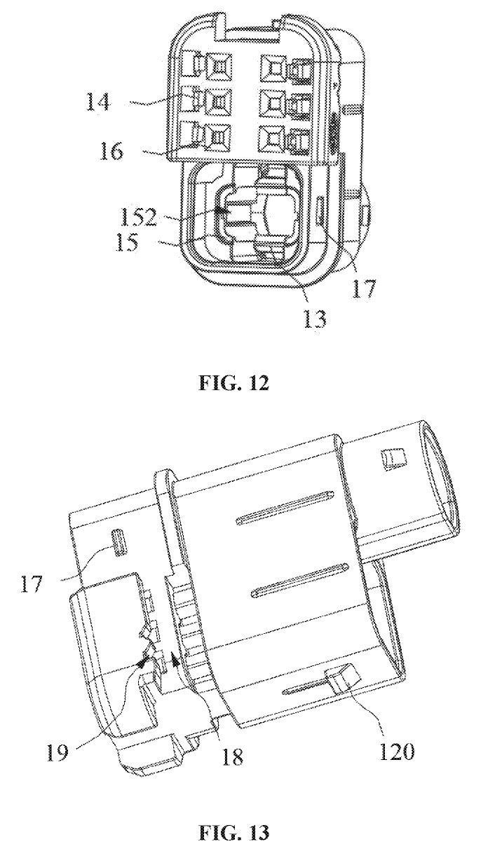

Specifically, referring to FIGS. 5 and 12, two first limiting stop blocks 15 are disposed opposite to each other in the second direction on the inner wall surface of the first mounting hole 11. The first stop surface 151 is formed on the inner side surfaces of the first limiting stop blocks 15 and configured to be gradually away from the hole wall of the first mounting hole 11 from the end near the first hole opening 111 towards the end away from the first hole opening 111. Correspondingly, the first abut surface 211 is also arranged inclined.

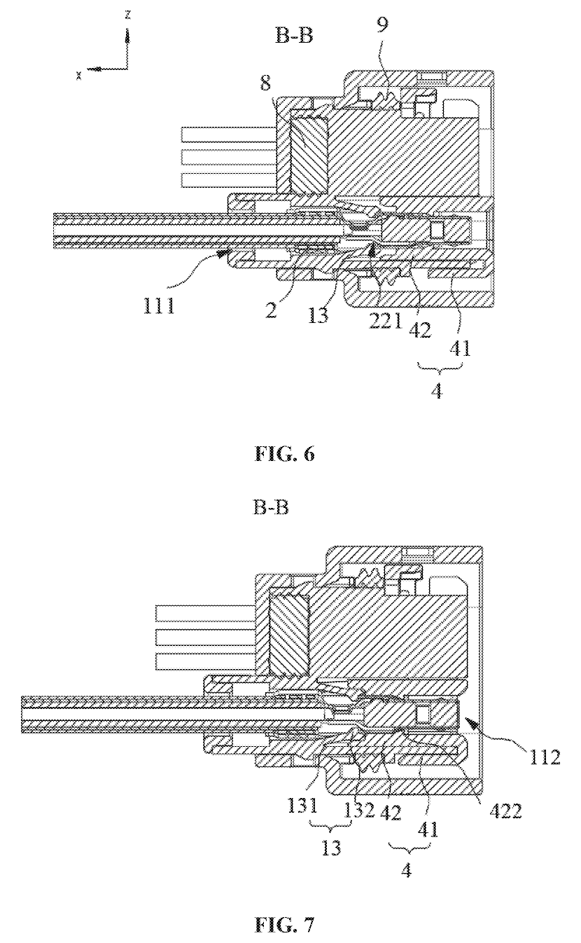

Referring to FIGS. 6 and 7, a first recess 221 is disposed on the outer wall surface of the first terminal 2. The first fastener 13 includes a first elastic arm 131 and a first snap block 132 that are integrally molded. One end of the first elastic arm 131 near the first hole opening 111 is connected to the hole wall of the first mounting hole 11, and the other end is gradually away from the hole wall of the first mounting hole 11 in the direction towards the second hole opening 112. The first snap block 132 is disposed on the side of the first elastic arm 131 away from the hole wall of the first mounting hole 11.

After the first terminal 2 is inserted into the first mounting hole 11 from the first hole opening 111, the first terminal 2 may press the first fastener 13. The first elastic arm 131 deforms to drive the first snap block 132 to move in the direction towards the hole wall of the first mounting hole 11 until the first snap block 132 is snapped into the first recess 221. At this point, the first stop surface 151 abuts against the first abut surface 211, and the first fastener 13 locks the first terminal 2 to prevent the first terminal 2 from moving in the direction towards the first hole opening 111.

Specifically, two first fasteners 13 are symmetrically disposed in the third direction in the first mounting hole 11 to improve the locking stability of the first fasteners 13 to the first terminal 2. More specifically, the two first fasteners 13 are disposed in two gaps formed by the two first limiting stop blocks 15 respectively and connected to the first limiting stop blocks 15 to improve the structural strength of the first fasteners 13.

More specifically, a first guide surface is disposed on the side of the first snap block 132 facing the first hole opening 111. The first guide surface is gradually away from the hole wall of the first mounting hole 11 from the side near the first hole opening 111 towards the side away from the first hole opening 111 to reduce the difficulty for the end of the first terminal 2 inserted into the first mounting hole 11 to traverse the first snap block 132 when moving in the direction towards the second hole opening 112.

In this embodiment, to reduce the difficulty when the first terminal 2 is inserted into the first mounting hole 11, the area of the first hole opening 111 is larger than the maximum cross-sectional area of the first terminal 2. On the above basis, the hybrid connector further includes an end cap 30. The end cap 30 is mounted on the insulating body 1 and located on the side of the first hole opening 111 of the first mounting hole 11. A threading hole through which the first cable 10 passes is opened on the end cap 30. The area of the threading hole is smaller than the area of the first hole opening 111.

After the first terminal 2 to which the first cable 10 is connected is inserted into the first mounting hole 11, the end cap 30 is mounted on the insulating body 1 to reduce the possibility of wobbling of the first cable 10, thereby improving the stability of the entire hybrid connector. Specifically, the end cover 30 is snap-fitted with the insulating body 1, thereby facilitating the maintenance and replacement of the first terminal 2.

Referring to FIG. 15, the first terminal 2 includes a front shielding case 21, an inner conductor, a cable clamp, and a rear shielding case 22. The rear end of the front shielding case 21 is sleeved on the rear shielding case 22 and crimped with the rear shielding case 22. The inner conductor is located inside the front shielding case 21 to be electrically connected to the first docking terminal and the cable. The cable clamp is located inside the rear shielding case 22 for fixing one end of the cable inside the rear shielding case 22. The front shielding case 21 is sequentially provided with a small-diameter section and a large-diameter section in the reverse direction of the first direction. The first abut surface 211 is formed between the large-diameter section and the small-diameter section. The rear shielding case 22 is set in a dumbbell shape. The first recess 221 is an annular groove formed on the rear shielding case 22, and the annular groove is located outside the front shielding case 21.

It is to be understood that in other embodiments, the first recess 221 may be disposed on the first elastic arm 131 and the first snap block 132 may be disposed on the first terminal 2.

Referring to FIGS. 12 and 15, to prevent the first terminal 2 from being inserted into the first mounting hole 11 too deep and avoid the resulting damage to the first terminal 2 or the insulating body 1, in this embodiment, a guide groove 152 extending in the first direction is further disposed on the inner side surface of the first limiting stop block 15. The side of the guide groove 152 near the second hole opening 112 is closed. A guide block 212 slidably fit with the guide groove 152 is disposed on the outer wall surface of the first terminal 2. When the first terminal 2 is in the preset position in the first mounting hole 11, the guide block 212 abuts against the groove wall of the guide groove 152 near an end of the second hole opening 112. Specifically, the guide block 212 is disposed on the outer wall surface of the large-diameter section.

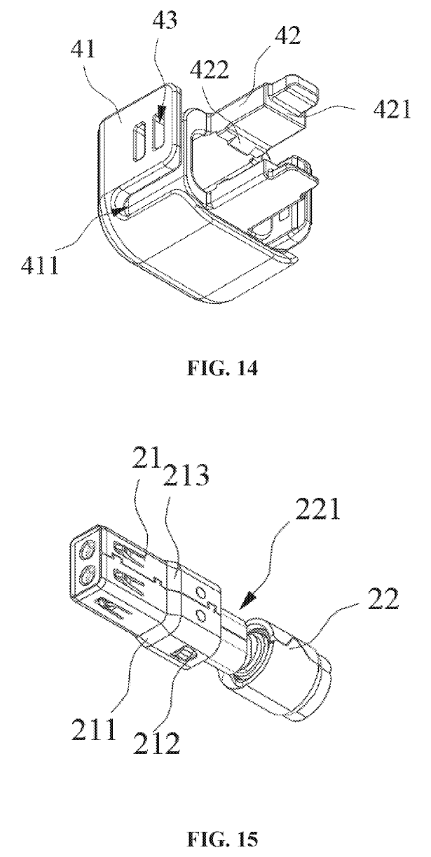

Referring to FIG. 14, the first locking member 4 includes a sleeve portion 41 and an insertion portion 42. The sleeve portion 41 is connected to the insertion portion 42 and located outside the insertion portion 42. A clamping space having an opening in the direction towards the first hole opening 111 is formed between the sleeve portion 41 and the insertion portion 42. The sleeve portion 42 is inserted into the first mounting hole 11 from the second hole opening 112. The sleeve portion 41 is sleeved outside the insulating body 1 to sandwich the insulating body 1 in the clamping space.

The first locking member 4 is inserted into the first mounting hole 11 from the second hole opening 112. Referring to FIGS. 6 and 7, when the first locking member 4 is in the pre-assembled position, the first locking member 4 and the first fastener 13 are disposed at intervals in the first direction, and the first locking member 4 does not interfere with the deformation of the first fastener 13 so that the first terminal 2 may be inserted into the preset position in the first mounting hole 11 from the first hole opening 111. When the first locking member 4 is in the final locking position, the first fastener 13 moves towards the first terminal 2 in the first direction, the inner side of the insertion portion 42 abuts against the side of the first fastener 13 facing away from the first terminal 2, and the first fastener 13 no longer has the ability to deform towards the hole wall of the first mounting hole 11 and is constantly snapped with the first terminal 2 due to the insertion portion 42, thereby maintaining the stability of the first terminal 2 when the first terminal 2 is inserted into the first mounting hole 11. It is worth emphasizing that when the first locking member 4 is in the final locking position, the end surface of the insulating body 1 abuts against the side of the clamping space away from the opening to stop the first locking member 4 from continuing to move in the direction towards the first hole opening 111.

Specifically, a step surface 421 is formed at the end of the insertion portion 42 inserted into the first mounting hole 11. When the first locking member 4 is in the final locking position, the first fastener 13 abuts against the step surface 421 to determine the final locking position of the first locking member 4, thereby further reducing the possibility that the first locking member 4 is excessively inserted into the first mounting hole 11.

A second stop surface 422 is further disposed on the side of the first locking member 4 facing the first terminal 2. The second stop surface 422 is gradually away from the hole wall of the first mounting hole 11 from the end near the first hole opening 111 towards the end away from the first hole opening 111. A second abut surface 213 fit with the second stop surface 422 is formed on the outer wall surface of the first terminal 2. When the first locking member 4 is in the final locking position, the second stop surface 422 abuts against the second abut surface 213, and in cooperation with the first stop surface 151 and the first abut surface 211, further stops the first terminal 2 from moving in the direction towards the second hole opening 112.

More specifically, two second stop surfaces 422 are disposed opposite to each other on the inner sidewall of the first locking member 4, and correspondingly, two second abut surfaces 213 are also disposed. The two second abut surfaces 213 are also formed between the small-diameter section and the large-diameter section of the front shielding case 21, that is, the second abut surfaces 213 and the first abut surfaces 211 form a tapered surface connecting the large-diameter section and the small-diameter section.

Referring to FIGS. 5 and 9, to facilitate observation of whether the first locking member 4 is in the pre-assembled position or the final locking position and to improve the stability of the first locking member 4 when the first locking member 4 is assembled on the insulating body 1, a first positioning block 17 is further disposed on one of the first locking member 4 and the insulating body 1, and a first groove hole 43 snap-fitted with the first positioning block 17 is disposed on the other of the first locking member 4 and the insulating body 1. Two first groove holes 43 are disposed at intervals in the first direction. When the first positioning block 17 is limited into one of the two first groove holes 43 away from the second hole opening 112, the first locking member 4 is in the pre-assembled position. When the first positioning block 17 is limited into one of the two first groove holes 43 near the second hole opening 112, the first locking member 4 is in the final locking position.

For example, the first positioning block 17 is disposed on the insulating body 1, and the first groove hole 43 is disposed on the first locking member 4. Specifically, the cross-section of the first positioning block 17 is set as an equilateral trapezoid or an equilateral triangle with a chamfer, thereby reducing the difficulty for the first positioning block 17 to enter and exit the first groove hole 43.

Referring to FIG. 14, to reduce the difficulty for the first locking member 4 to be disengaged from the insulating body 1, the sleeve portion 41 is formed with an avoidance notch 411. The avoidance notch 411 extends in the first direction to the end surface of the sleeve portion 41 near the first terminal 2. When the first locking member 4 is detached, the first positioning block 17 may be disengaged from the first groove hole 43 by applying a force away from the insulating body 1 in the second direction to the sleeve portion 41.

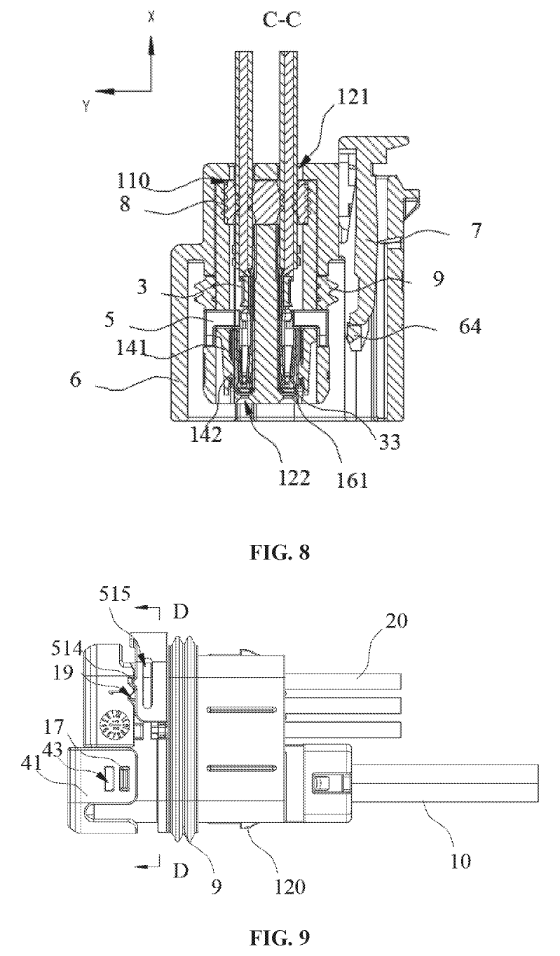

Referring to FIG. 8, the second mounting hole 12 has a third hole opening 121 and a fourth hole opening 122 opposite to each other in the first direction. The third hole opening 121 and the first hole opening 111 are located on the same side of the insulating body 1. A third stop surface 161 is disposed on the side of the second mounting hole 12 near the fourth hole opening 122. The third stop surface 161 may abut against a third abut surface 33 on the second terminal 3 to stop the second terminal 3 from continuing to move in the direction towards the fourth hole opening 122 so that the second terminal 3 is inserted into the preset position in the second mounting hole 12.

Specifically, an annular second limiting stop block 16 is disposed on the side of the second mounting hole 12 near the fourth hole opening 122. The third stop surface 161 is formed on the side of the second limiting stop block 16 facing away from the fourth hole opening 122 and is set as a tapered surface. The third stop surface 161 gradually increases from the end near the fourth hole opening 122 towards the end away from the fourth hole opening 122. The tapered third abut surface 33 is formed on the outer wall surface of the second terminal 3. When the third abut surface 33 abuts against the third stop surface 161, the second terminal 3 is inserted into the preset position in the second mounting hole 12.

Referring to FIGS. 8 and 17, a second recess 31 is disposed on the outer wall surface of the second terminal 3. The second fastener 14 includes a second elastic arm 141 and a second snap block 142 that are integrally molded. One end of the second elastic arm 141 near the third hole opening 121 is connected to the hole wall of the second mounting hole 12, and the other end is gradually away from the hole wall of the second mounting hole 12 in the direction towards the fourth hole opening 122. The second snap block 142 is disposed on the side of the second elastic arm 141 away from the hole wall of the second mounting hole 12. Specifically, the second recess 31 is a recessed groove formed on the outer wall surface of the second terminal 3.

After the second terminal 3 is inserted into the second mounting hole 12 from the third hole opening 121, the second terminal 3 may press the second fastener 14. The second elastic arm 141 deforms to drive the second snap block 142 to move in the direction towards the hole wall of the second mounting hole 12 until the second snap block 142 is snapped into the second recess 31. At this point, the third stop surface 161 abuts against the third abut surface 33 and in cooperation with the second fastener 14, locks the second terminal 3.

In this embodiment, a second guide surface is further disposed on the side of the second snap block 142 facing the third hole opening 121. The second guide surface is gradually inclined from the side near the third hole opening 121 towards the center of the second mounting hole 12 to reduce the difficulty for the end of the second terminal 3 inserted into the second mounting hole 12 to traverse the second snap block 142 when moving in the direction towards the fourth hole opening 122.

It is to be understood that the positions of the second recess 31 and the second snap block 142 may be interchanged between the second elastic arm 141 and the second terminal 3.

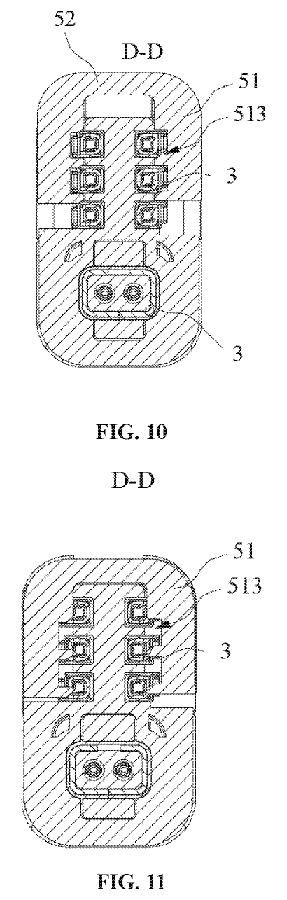

The second locking member 5 is inserted into the insulating body 1 in the reverse direction of the third direction from the side away from the first terminal 2. In this embodiment, referring to FIGS. 10, 11 and 16, an avoidance groove 513 penetrating in the first direction is disposed on the second locking member 5. The avoidance groove 513 on the second locking member 5 in the pre-assembled position faces the second terminal 3 to allow the second terminal 3 to be inserted into or disengaged from the second mounting hole 12. The avoidance groove 513 on the second locking member 5 in the final locking position is staggered with respect to the second terminal 3, and the second terminal 3 is locked inside the second mounting hole 12.

To avoid the second locking member 5 when the second locking member 5 moves in the third direction, the second terminal 3 is provided with an avoidance groove 32. On the premise that the second terminals 3 are arranged in rows in the third direction, multiple avoidance grooves 32 on the second terminals 3 are arranged in the third direction, and the same number of avoidance grooves 513 as the second terminals 3 are disposed on the second locking member 5.

In other embodiments, the second locking member 5 may lock the second terminal 3 in a snap-fitting manner.

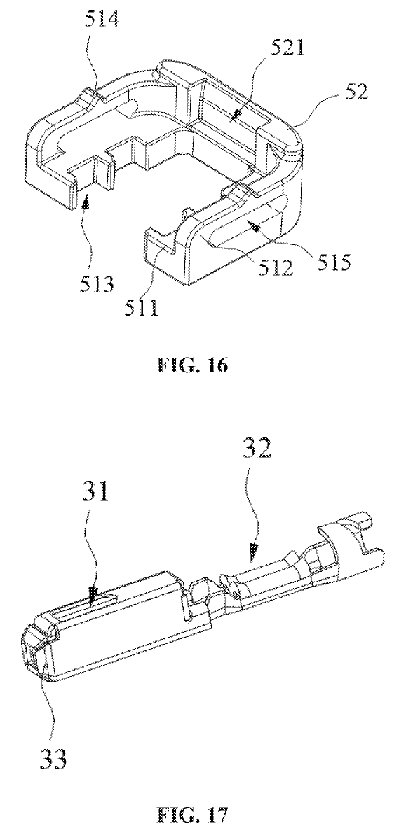

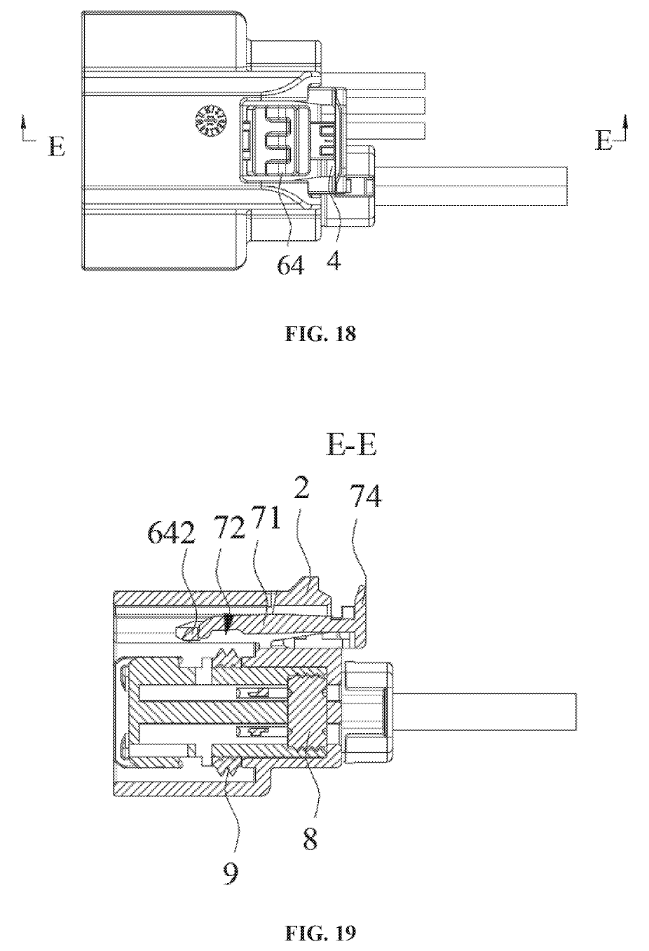

Taking an example in which two rows of second terminal 3 are symmetrically disposed at intervals in the second direction, still referring to FIG. 16, the second locking member 5 includes a connecting portion 52 and two cantilever portions 51. The connecting portion 52 extends in the second direction, and the two cantilever portions 51 are disposed on opposite sides of the connecting portion 52 in the second direction respectively and perpendicular to the connecting portion 52 to make the second locking member 5 approximately U-shaped. Based on the setting of the avoidance grooves 513, the avoidance grooves 513 are disposed on the cantilever portions 51. When the cantilever portions 51 are inserted into the insulating body 1 and the second terminals 3 are in the pre-assembled position, the avoidance grooves 513 on the cantilever portions 51 are in one-to-one correspondence with the second terminals 3 so that the insertion of the second terminals 3 into the second mounting hole 12 or the or disengagement of the second terminals 3 from the second mounting hole 12 is not affected. When the cantilever portions 51 continue to be inserted into the insulating body 1 and the second terminals 3 reach the final locking position, each of the avoidance grooves 513 is staggered with the respective one of the second terminals 3, thereby preventing the second terminals 3 from moving in the direction towards the fourth hole opening 122.

Referring to FIG. 13, to provide guidance for the second terminal 3 when the second terminal 3 is inserted into the insulating body 1, two fixing grooves 18 extending in the third direction are disposed on the outer wall of the insulating body 1. The two fixing grooves 18 communicate with two rows of second mounting holes 12, respectively, and two cantilever portions 51 are inserted into the insulating body 1 along the two fixing grooves 18, respectively.

Further, to facilitate observation of whether the second locking member 5 is in the pre-assembled position or the final locking position and to improve the stability of the second locking member 5 when the second locking member 5 is assembled on the insulating body 1, a second positioning block 514 is further disposed on one of the second locking member 5 and the insulating body 1, and a second groove hole 19 snap-fitted with the second positioning block 514 is disposed on the other of the second locking member 5 and the insulating body 1. Two second groove holes 19 are disposed at intervals in the third direction. When the second positioning block 514 is limited into one of the two second groove holes 19 away from the first terminal 2, the second locking member 5 is in the pre-assembled position. When the second positioning block 514 is limited into one of the two second groove holes 19 near the first terminal 2, the second locking member 5 is in the final locking position.

For example, the second positioning block 514 is disposed on the cantilever portion 51 of the second locking member 5, and one second positioning block 514 is disposed on each of the two cantilever portions 51. The second groove holes 19 corresponding to the second positioning blocks 514 are disposed on the groove sidewalls of the two fixing grooves 18, respectively.

To reduce the difficulty for the second positioning block 514 to enter the second groove hole 19, the second positioning block 514 is designed in a triangular shape, and meanwhile, a strip-shaped avoidance hole 515 extending in the third direction is further disposed on the second locking member 5. When the second positioning block 514 enters the second groove hole 19, the avoidance hole 515 provides an avoidance space for the second locking member 5 for deformation. Specifically, the cantilever portion 51 further includes a mounting portion 512 and a locking portion 511 that are designed in an L shape. Both the mounting portion 512 and the locking portion 511 are connected to the connecting portion 52. The mounting portion 512 is capable of sliding in the fixing groove 18, and the locking portion 511 is inserted into the second mounting hole 12. The second positioning block 514 and the avoidance groove 513 are disposed on the mounting portion 512 and the locking portion 511, respectively. The strip-shaped avoidance hole 515 extending in the third direction is disposed on the mounting portion 512 to enhance the plasticity of the second locking member 5, reduce the difficulty for the second locking member 5 to switch between the pre-assembled position and the final locking position, and lower the material cost for manufacturing the second locking member 5.

More specifically, to reduce the difficulty of disassembling the second locking member 5, a force application groove 521 is further opened on the connecting portion 52 to facilitate force application. The force application groove 521 extends to the surface of the connecting portion 52 in the reverse direction of the first direction.

Referring to FIGS. 3 and 8, the hybrid connector further includes a first sealing ring 8. The first sealing ring 8 is disposed at the fourth hole opening 122 of the second mounting hole 12 and provided with a through hole 84 through which the second cable 20 passes. The first sealing ring 8 is capable of sealing the gap between the fourth hole opening 122 and the second terminal 3 to achieve dustproof and waterproof effects.

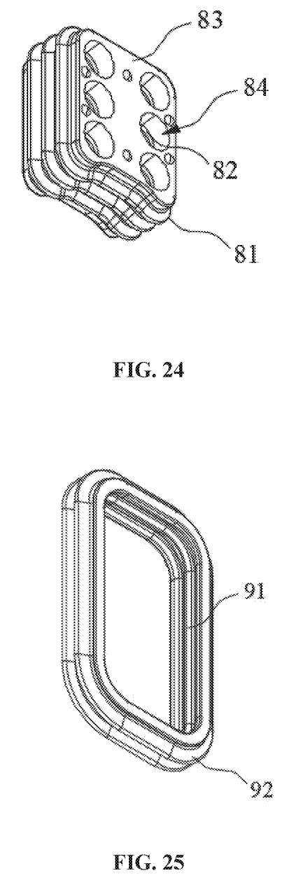

Referring to FIG. 24, on the premise that multiple second terminals 3 are disposed, the first sealing ring 8 adopts a grouped sealing ring. Multiple through holes 84 which are in one-to-one correspondence to multiple second mounting holes 12 are disposed on the grouped sealing ring. Specifically, a mounting groove 110 communicating with each of the second mounting holes 12 is disposed on the insulating body 1, and the first sealing ring 8 is mounted in the mounting groove 110. To improve the sealing performance of the first sealing ring 8, the first sealing ring 8 includes a sealing body 83 and multiple first annular protrusions 81 disposed at intervals on the outer wall surface of the sealing body 83 in the first direction. The first annular protrusions 81 are annularly disposed to increase the contact area with the groove sidewall of the mounting groove 110, thereby improving the sealing performance. Meanwhile, multiple second annular protrusions 82 are disposed at intervals on the hole wall of each through hole 84 in the first direction. The second annular protrusions 82 are likewise annularly disposed to increase the contact area with the second cable 20, thereby improving the sealing performance.

Referring to FIGS. 1-3, the hybrid connector further includes a housing 6. The housing 6 has an inner cavity which is open on one side in the first direction. The insulating body 1 is located inside the inner cavity of the housing 6, and the housing 6 is used for protecting the insulating body 1. An operation hole 61 communicating with the inner cavity of the housing 6 is disposed at a position on the housing 6 corresponding to the connecting portion 52 of the second locking member 5. A force may be applied to the second locking member 5 in the direction towards the first terminal 2 through the operation hole 61 so that the second locking member 5 switches from the pre-assembled position to the final locking position.

It is worth emphasizing that the length of the operation hole 61 in the second direction is smaller than the length of the connecting portion 52 in the second direction. In other words, the orthographic projection area of the second locking member 5 in a direction towards the operation hole 61 is larger than the area of the operation hole 61 to prevent the second locking member 5 from being disengaged from the insulating body 1 from the operation hole 61 or being pressed to the final locking position during transportation.

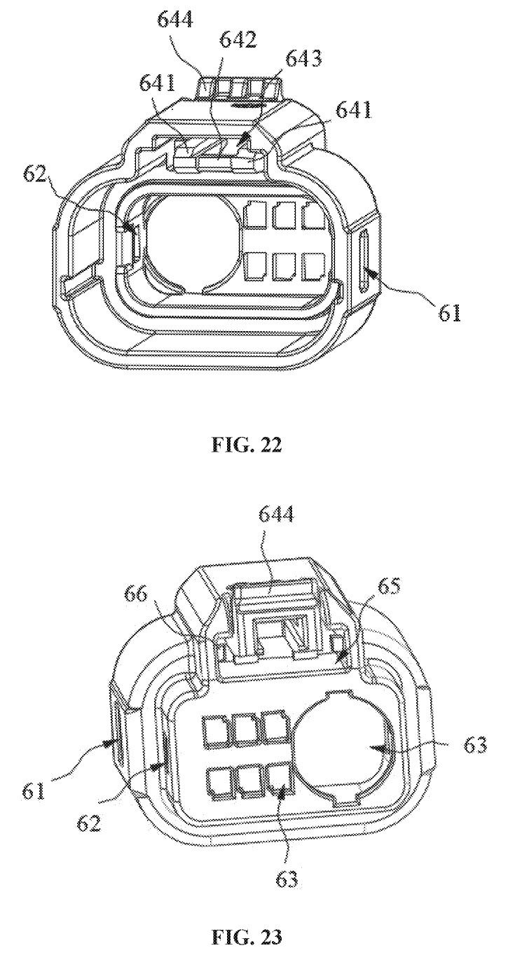

Specifically, referring to FIGS. 22 and 23, a third groove hole 62 is disposed on the housing 6, and a third positioning block 120 snap-fitted with the third groove hole 62 is disposed on the insulating body 1. The third positioning block 120 is limited into the third groove hole 62 to achieve the detachable fixed connection between the insulating body 1 and the housing 6. More specifically, two third groove holes 62 are symmetrically disposed on the housing 6 in the third direction, and two third positioning blocks 120 are also disposed to improve the connection stability between the housing 6 and the insulating body 1. An inclined third guide surface is formed at the end of the third positioning block 120 facing away from the groove opening of the housing 6 to reduce the difficulty for the third positioning block 120 to be snapped into the third groove hole 62. Of course, the third groove hole 62 may be disposed on the insulating body 1 and the third positioning block 120 may be disposed on the housing 6.

Referring to FIGS. 5, 8, and 23, both the first hole opening 111 and the third hole opening 121 on the insulating body 1 face the closed end of the housing 6, and multiple outlet holes 63 allowing the first cable 10 and the second cable 20 to pass through are disposed at the positions corresponding to the first mounting hole 11 and the second mounting hole 12 at the closed end of the housing 6. The docking connector may be electrically connected to the hybrid connector from the open end of the housing 6.

A gap exists between the end of the insulating body 1 near the open end of the housing 6 and the housing 6 for insertion of the docking connector. To lock the docking connector to the hybrid connector, the housing 6 further includes a third fastener 64 disposed on the inner wall of the housing 6. The third fastener 64 is snap-fitted with the hybrid connector.

Specifically, referring to FIGS. 19 and 22, the third fastener 64 includes a third elastic arm 641 and a third recess 643. The third elastic arm 641 is connected to the inner wall of the housing 6. The third recess 643 is disposed at the end of the third elastic arm 641 extending in the direction towards the groove opening. A third snap block engaged with the third recess 643 is formed on the docking connector. The third snap block may be snapped into the third recess 643 to achieve the locking of the docking connector.

More specifically, two third elastic arms 641 are disposed at intervals in the third direction. The two third elastic arms 641 are connected to each other through a connecting rod 642 to form the above-described third recess 643 between the two third elastic arms 641, and the third snap block is snapped into the third recess 643 and abuts against the connecting rod 642.

Referring to FIGS. 19 and 23, an insertion hole 65 for the third fastener 64 to extend into the inner cavity of the housing 6 is formed at the closed end of the housing 6. The insertion hole 65 communicates with the inner cavity of the housing 6. The third elastic arm 641 is connected to the hole wall of the insertion hole 65 through a fulcrum. One end of the third elastic arm 641 connected to the connecting rod 642 extends from the insertion hole 65 into the inner cavity of the housing 6, and the other end is located outside the housing 6. The locking of the docking connector by the third fastener 64 may be released only by pressing the end of the third elastic arm 641 located outside the housing 6.

To further improve the stability between the hybrid connector and the docking connector, the hybrid connector further includes a third locking member 7. The third locking member 7 also has a pre-assembled position and a final locking position. The third locking member 7 in the pre-assembled position allows the docking connector to be inserted into a preset position in the housing 6, and the third locking member 7 in the final locking position enables the third fastener 64 to keep locking the docking connector.

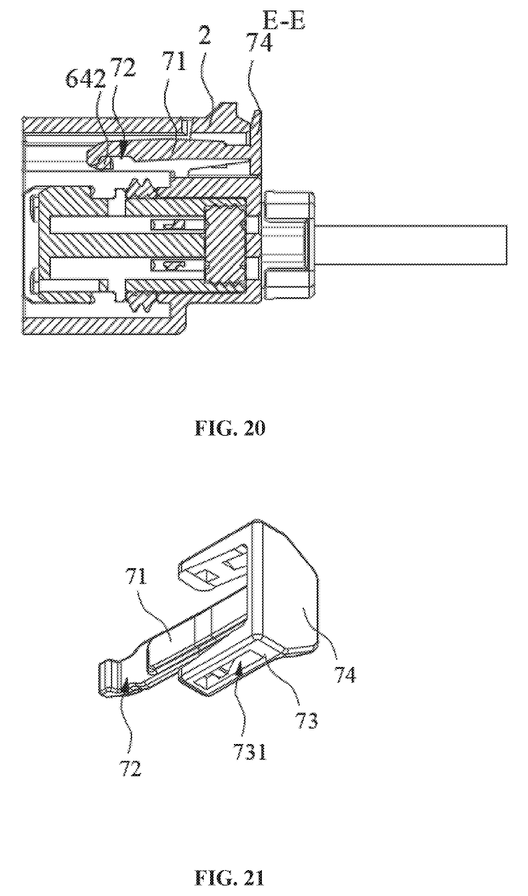

Still referring to FIGS. 19 and 20, the third locking member 7 is inserted into the housing 6 from the closed end of the housing 6 in the first direction. The third locking member 7 includes a locking arm 71. The end of the locking arm 71 of the third locking member 7 in the pre-assembled position is located on the side of the connecting rod 642 facing away from the open end of the housing 6. The locking arm 71 of the third locking member 7 in the final locking position abuts against the outside of the third fastener 64 to stop the third fastener 64 from moving to the side away from the third snap block. Specifically, a locking groove 72 is disposed on the locking arm 71. The connecting rod 642 may be snapped into the locking groove 72 and abut against the groove bottom of the locking groove 72.

Referring to FIGS. 21 and 23, to improve the stability of the third locking member 7 when the third locking member 7 is assembled on the housing 6, a fourth positioning block 66 is further disposed on one of the third locking member 7 and the housing 6, and a fourth groove hole 731 snap-fitted with the fourth positioning block 66 is disposed on the other of the third locking member 7 and the housing 6. Two fourth groove holes 731 are disposed at intervals in the first direction. When the fourth positioning block 66 is snapped into one of the two fourth groove holes 731 away from the open end of the housing 6, a third locking member 7 is in the pre-assembled position. When the fourth positioning block 66 is snapped into one of the two fourth groove holes 731 near the open end of the housing 6, the third locking member 7 is in the final locking position.

For example, a third groove hole 62 is disposed on the third locking member 7 and the third positioning block 120 is disposed on the housing 6 and specifically disposed on the hole wall of the insertion hole 65. Specifically, the third locking member 7 includes two positioning arms 73 disposed at intervals on opposite sides of the locking arm 71 in the third direction. The two positioning arms 73 are connected to the locking arm 71 and inserted into the insertion hole 65. The third groove holes 62 are formed in the positioning arms 73. Meanwhile, to reduce the difficulty of disassembling and assembling the third locking member 7, the third locking member 7 further includes a push-pull plate 74. The push-pull plate 74 connects the locking arm 71 and the ends of the positioning arms 73 located outside the housing 6.

Still referring to FIG. 23, to facilitate the application of force to the third fastener 64 so that the docking connector is disengaged from the hybrid connector, the ends of the two third elastic arms 641 away from the connecting rod 642, that is, the ends of the two third elastic arms 641 located outside the housing 6, are connected to a U-shaped connecting block 644. The two third elastic arms 641 are connected to both ends of the connecting block 644, respectively. By applying a pressure to the connecting block 644, the third elastic arms 641 may move in the direction away from the third snap block under leverage, thereby disengaging the third elastic arms 641 from the third snap block. When the locking arms 71 of the third locking member 7 pass through the connecting block 644 and are inserted into the housing 6, the unlocking of the third locking member 7 and the unlocking of the third fastener 64 do not interfere with each other.

Referring to FIGS. 3 and 19, the hybrid connector further includes a second sealing ring 9. The second sealing ring 9 is sleeved on the insulating body 1 and located in the gap formed between the insulating body 1 and the housing 6. The second sealing ring 9 may abut against the docking connector inserted into the housing 6 to achieve the sealing between the docking connector and the insulating body 1, thereby further improving the waterproof and dustproof performance of the connector assembly.

Specifically, multiple third annular protrusions 91 and multiple fourth annular protrusions 92 are disposed at intervals on the inner peripheral wall and the outer peripheral wall of the second sealing ring 9 in the first direction, respectively, to increase the contact area between the second sealing ring 9 and the insulating body 1 and between the second sealing ring 9 and the docking connector, thereby improving the sealing performance.

When the above hybrid connector is assembled, the injection-molded second locking member 5 is inserted into the insulating body 1 in the third direction to make the second locking member 5 in the pre-assembled position. The second sealing ring 9 is then sleeved on the insulating body 1. The injection-molded first locking member 4 is inserted into the first mounting hole 11 in the first direction to make the first locking member 4 in the pre-assembled position. The first sealing ring 8 is mounted in the mounting groove 110. The housing 6 is sleeved on the insulating body 1. The third locking member 7 is inserted into the housing 6. Finally, the first terminal 2 and the second terminal 3 are inserted, and the first locking member 4 and the second locking member 5 are pushed to the final locking positions if needed.

When the first terminal 2 needs to be disassembled from the first mounting hole 11 to replace a new first terminal 2, the first locking member 4 may be removed from the insulating body 1 by means of a tool, and then a tool is inserted into the first mounting hole 11 to pry the first fastener 13 in the direction towards the hole wall of the first mounting hole 11 so that the first terminal 2 may be disengaged from the insulating body 1, thereby effectively reducing the fault maintenance costs. When the second terminal 3 needs to be disassembled from the second mounting hole 12 to replace a new second terminal 3, a force away from the insulating body 1 in the third direction may be applied to the second locking member 5 through the force application groove 521 to disengage the second locking member 5 from the insulating body 1, a tool extends into the second mounting hole 12 to apply a force away from the second terminal 3 to the second fastener 14 so that the second fastener 14 is disengaged from the second terminal 3, and then the second terminal 3 may be disengaged from the insulating body 1. When the docking connector needs to be separated from the hybrid connector, a pressure is applied to the push-pull plate 74 of the third locking member 7 to disengage the end of the third locking member 7 engaged with the third fastener 64 from the third fastener 64, the third locking member 7 is removed from the housing 6, a pressure is applied to the connecting block 644 of the third locking member 64 to disengage the end of the third fastener 64 snapped with the docking connector from the docking connector, and then the docking connector may be removed from the housing 6.

Apparently, the preceding embodiments of the present application are only illustrative examples of the present application and are not intended to limit embodiments of the present application. Those of ordinary skill in the art can make various apparent modifications, adaptations, and substitutions without departing from the scope of the present application. All embodiments do not need to be and cannot be exhausted herein. Any modifications, equivalent substitutions, and improvements made within the spirit and principle of the present application fall within the scope of the claims of the present application.

What is claimed is:

1. A hybrid connector, comprising:
an insulating body, wherein a first mounting hole and a second mounting hole are disposed on the insulating body, a first fastener is disposed in the first mounting hole, and a second fastener is disposed in the second mounting hole;
a first terminal inserted into the first mounting hole and snap-fitted with the first fastener;
a first locking member detachably inserted into the insulating body and fitted with the first fastener in a position-limiting manner;
a second terminal inserted into the second mounting hole and snap-fitted with the second fastener; and
a second locking member detachably inserted into the insulating body and capable of locking the second terminal snap-fitted with the second fastener.

2. The hybrid connector according to claim 1, further comprising at least one of the following:
the first locking member has a pre-assembled position and a final locking position with respect to the insulating body, the first locking member in the pre-assembled position is configured to allow the first terminal to be inserted into the first mounting hole, and the first locking member in the final locking position is configured to limit a position of the first terminal; or
the second locking member has a pre-assembled position and a final locking position with respect to the insulating body, the second locking member in the pre-assembled position is configured to allow the second terminal to be inserted into or removed from the second mounting hole, and the second locking member in the final locking position is configured to lock the second terminal.

3. The hybrid connector according to claim 2, wherein the first mounting hole and the second mounting hole extend in a first direction, the first locking member is configured to move in the first direction to switch between the pre-assembled position and the final locking position, and the second locking member is configured to move in a third direction to switch between the pre-assembled position and the final locking position, wherein the third direction is perpendicular to the first direction.

4. The hybrid connector according to claim 2, wherein the first locking member comprises a sleeve portion and an insertion portion, the sleeve portion is connected to the insertion portion and located outside the insertion portion, the sleeve portion is sleeved outside the insulating body, and when the first locking member is in the final locking position, an inner side of the insertion portion abuts against a side of the first fastener facing away from the first terminal.

5. The hybrid connector according to claim 2, wherein an avoidance groove is disposed on the second locking member, the avoidance groove on the second locking member in the pre-assembled position faces the second terminal, and the avoidance groove on the second locking member in the final locking position is staggered with respect to the second terminal.

6. The hybrid connector according to claim 2, further comprising a housing, wherein the housing is sleeved on the insulating body.

7. The hybrid connector according to claim 6, wherein an operation hole is opened on a side of the housing corresponding to the second locking member, and an orthographic projection area of the second locking member in a direction towards the operation hole is larger than an area of the operation hole.

8. The hybrid connector according to claim 6, further comprising a third locking member, wherein the third locking member is configured to be inserted into the housing and capable of locking a docking connector plug-fitted with the hybrid connector.

9. The hybrid connector according to claim 1, wherein the first terminal is a terminal for transmitting an Ethernet signal, and the second terminal is a low-voltage terminal.

10. The hybrid connector according to claim 3, further comprising a housing, wherein the housing is sleeved on the insulating body.

11. The hybrid connector according to claim 4, further comprising a housing, wherein the housing is sleeved on the insulating body.

12. The hybrid connector according to claim 5, further comprising a housing, wherein the housing is sleeved on the insulating body.

13. The hybrid connector according to claim 2, wherein the first terminal is a terminal for transmitting an Ethernet signal, and the second terminal is a low-voltage terminal.

14. The hybrid connector according to claim 3, wherein the first terminal is a terminal for transmitting an Ethernet signal, and the second terminal is a low-voltage terminal.

15. The hybrid connector according to claim 4, wherein the first terminal is a terminal for transmitting an Ethernet signal, and the second terminal is a low-voltage terminal.

16. The hybrid connector according to claim 5, wherein the first terminal is a terminal for transmitting an Ethernet signal, and the second terminal is a low-voltage terminal.

17. A connector assembly, comprising a hybrid connector and a docking connector plug-fitted with the hybrid connector,
wherein the hybrid connector comprises:
an insulating body, wherein a first mounting hole and a second mounting hole are disposed on the insulating body, a first fastener is disposed in the first mounting hole, and a second fastener is disposed in the second mounting hole;
a first terminal inserted into the first mounting hole and snap-fitted with the first fastener;
a first locking member detachably inserted into the insulating body and fitted with the first fastener in a position-limiting manner;
a second terminal inserted into the second mounting hole and snap-fitted with the second fastener; and
a second locking member detachably inserted into the insulating body and capable of locking the second terminal snap-fitted with the second fastener.

18. The connector assembly according to claim 17, further comprising at least one of the following:
the first locking member has a pre-assembled position and a final locking position with respect to the insulating body, the first locking member in the pre-assembled position is configured to allow the first terminal to be inserted into the first mounting hole, and the first locking member in the final locking position is configured to limit a position of the first terminal; or
the second locking member has a pre-assembled position and a final locking position with respect to the insulating body, the second locking member in the pre-assembled position is configured to allow the second terminal to be inserted into or removed from the second mounting hole, and the second locking member in the final locking position is configured to lock the second terminal.

19. The connector assembly according to claim 18, wherein the first mounting hole and the second mounting hole extend in a first direction, the first locking member is configured to move in the first direction to switch between the pre-assembled position and the final locking position, and the second locking member is configured to move in a third direction to switch between the pre-assembled position and the final locking position, wherein the third direction is perpendicular to the first direction.

20. The connector assembly according to claim 18, wherein the first locking member comprises a sleeve portion and an insertion portion, the sleeve portion is connected to the insertion portion and located outside the insertion portion, the sleeve portion is sleeved outside the insulating body, and when the first locking member is in the final locking position, an inner side of the insertion portion abuts against a side of the first fastener facing away from the first terminal.
